(19) United States
(12) Patent Application Publication
(10) Pub. No.: US 2006/0289046 A1
(43) Pub. Date: Dec. 28, 2006

(54) Mobility assistance devices

(76) Inventor: Wayland H. Cato III, Charlotte, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/165,307

(22) Filed: Jun. 23, 2005

(51) Int. Cl. A61H 3/02; A47C 31/11

(52) U.S. Cl. 135/73; 135/75; 297/183.9; 5/662

(57) ABSTRACT

Devices for assisting a frail or physically handicapped user include an angled handgrip that is positioned for use by the user in rising from a seated or reclined position. The device may be in the form of a crutch in which the handgrip projects rearwardly from the upper end of the crutch, preferably at an angle of about 45° from vertical. Alternatively, the device may be in the form of a telescoping shaft that is attached to a frame member of a chair or bed, with the handgrip projecting rearwardly from the upper end of the telescoping shaft.

### BACKGROUND OF THE INVENTION

(1) Field of the Invention

The present invention relates generally to a telescoping crutch and other mobility assistance devices for use by the frail or physically handicapped, and in particular to crutch and other devices that include means to assist a user in rising from a reclined or seated position.

(2) Description of the Prior Art

Many individuals, due to frailties or physical impairments, find it difficult to rise from a reclined or seated position to a standing position. For example, an individual may have sufficient strength to achieve mobility with the use of crutches or a walker, but may not be able to do so without assistance because of their inability to rise from a seated or reclined position to a standing position permitting use of the crutches or walker. The individual may be in a wheelchair or on a bed and wish to move to another location. The individual's strength may not be sufficient to enable the individual to rise in the same manner as an individual having full body strength, i.e., by simply using leg strength and/or by pushing downward on a part of the chair or bed.

Thus, there is a continuing need for assistance devices to enable an individual of limited strength to rise from a seated or reclined position.

### SUMMARY OF THE INVENTION

Generally, the present invention addresses this need by providing a telescoping lift device that is moveable to a desired position, or affixed to a chair or bed. The device is comprised of an angled handgrip to be grasped by the individual, and a telescoping shaft having an upper end for attachment of the handgrip.

The device may form a part of a crutch employed by the individual after rising. Alternatively, the device may be attached to a chair or bed so that the handgrip may be conveniently grasped by the individual when in the seated or reclined position. In these embodiments, the device further includes attachment means at the lower end of the telescoping shaft for releasibly attaching the shaft to the chair or bed. The exact construction of the chair or bed does not per se form an element of the invention. Upon reading of the detailed description of the invention, it will be apparent that the invention is applicable to a variety of chairs and beds. In its broad context, the term “chair” is intended to encompass such diverse seating devices as conventional straight chairs, wheelchairs and toilets. Beds may be of the construction used in a residence, or the type used on hospitals and nursing homes, where mechanisms for altering the position of the bed are included in the bed construction.

A crutch incorporating the device of the present invention is comprised of a telescoping shaft that is positioned generally vertically when the crutch is used. The crutch has upper and lower ends, a generally horizontal underarm support secured to the shaft beneath the upper end of the shaft, a primary handgrip adjustably attachable onto the shaft beneath the underarm support where the handgrip can be easily grasped by the user's, and a lifting handgrip projecting at an angle upwardly and outwardly from the upper end of the telescoping shaft.

The shaft is constructed of upper and lower tubular sections, with one of the sections being slidable within the interior of the other section. For this purpose, the inner diameter of the outer tubular section will be approximately equal to the outer diameter on the inner tubular section. Preferably, the outer section forms the upper end of the shaft, with the inner section being extendable from the lower end of the upper tubular section.

A mechanism of the type known in the art is provided for releasibly securing the tubular sections together at the desired telescoped length. For example, the outer section may include a plurality of equally spaced, axially aligned holes for selectively receiving a spring-loaded button carried near the upper end of the inner section, so that the two sections can be releasibly locked together. Alternatively, the inner wall of the outer section may include a helical groove, while the outer wall includes an inwardly projecting tang positionable within the groove so that the sections, upon rotation relative to each other will extend or retract. In this latter embodiment, a locking mechanism, generally a rotatable collar, is provided to secure the two sections at the desired telescoped length. In a third embodiment, the diameters of the two sections are slightly oval, so that rotation of the sections relative to each other will permit sliding of the sections, or will frictionally lock the sections together.

The inner section is approximately the same length as the outer section, so that the inner section can be substantially completely inserted into the interior of the outer section when the crutch is not in use, thereby providing an optimally compact configuration that is approximately one-half the length of the fully extended crutch.

For example the fully extended length of the crutch, not including the auxiliary lift handgrip, may be about 66″, with the outer section comprising about 34″ of the overall length.

The primary handgrip is comprised of a gripping member extending substantially transversely from the shaft, the gripping member being slightly longer than the width of a user's hand, e.g., about 5½″ long. A resilient covering may be placed over the gripping member to relieve the pressure on the user's hand during use of the crutch. A band or clamp extendable around the outer shaft section is attached to the inner end of the gripping member, so that the primary handgrip can be slidably attached to the shaft. The band is sized to fit between adjacent holes forming a part of the locking mechanism so as not to interfere with the mechanism.

The underarm support may be similarly constructed with a transversely extending underarm member and a clamping member. Alternatively, the underarm member of the underarm support, which may be approximately the same length as the gripping member of the primary handgrip, can be fixedly attached to the upper end of the tubular shaft, with an additional shaft section extending between the underarm support and the auxiliary handgrip.

The lifting handgrip extends from the upper end of the shaft, or the upper end of the additional shaft section, at an angle of approximately 30° to 60°, and preferably approximately 45°, from vertical. The lifting handgrip may also be about 5½″ in length, and covered with a foam or resilient covering. A crutch tip may be fitted to the lower end of the lower shaft section.

For economy of manufacture, the crutch of the present invention can be made essentially of aluminum tubing, with the various sections being attached with fittings, such as copper plumbing fittings. In addition to the aluminum tubing and copper fittings, the crutch will normally include the aforementioned handgrip coverings, the crutch tip, and end caps that are fitted into exposed ends of the tubular handgrips.

When used to assist a user in rising from a seated or reclined position, the crutch, which may first be shortened, is held in a generally upright position. The user then reaches up to grasp the auxiliary handgrip, pulling upward to a standing position. The crutch, if initially shortened to assist the user in rising, may be lengthened so that the upper section fits beneath the user's arm. Alternatively, the crutch may be used as a cane, with the user pressing downward on the auxiliary lift handgrip. When used as a crutch, the underarm support is placed loosely beneath the user's arm and the user rests his or her hand on the gripping member.

The crutch, or parts thereof, can also be used in other ways to assist a user in walking, or in rising to a standing position. For example, the underarm and primary handgrip can be removed, and a free-standing foot added to the lower end of the telescoping shaft to form a cane. Also, the telescoping shaft with the auxiliary handgrip can be attached to a wheelchair, chair, bed, or toilet, to assist the user in rising to a standing position, or in sitting down. The handgrip may be hinged, so that it can be folded down out of the way when not in use.

When used to assist in rising from a wheelchair or other chair, the device is comprised of a telescoping shaft as described above, with the shaft having upper and lower telescoping and releasibly locking sections. A lifting handgrip extends at an angle from the upper end of the upper telescoping section, while the lower end of the lower telescoping section is adapted to be releasibly attached to the chair, e.g., to the chair frame. The angle of the telescoping shaft relative to the chair may vary depending on how the shaft is attached to the chair. For example, the shaft may extend forward from the front of the chair at an angle of from about 100 to 30°.

However, when attached, the lift handgrip should project toward the back of the chair at an angle of approximately 30° to 60°, and preferably approximately 45°, from vertical, with the handgrip being positioned so that it can be easily reached by a person seated in the chair. When used, the individual simply reaches upward to grip the lift handgrip and pull himself or herself upward to a standing position, permitting the individual to use crutches, or move to another seat or a bed.

The device may also be attached to the frame of a bed. For this purpose, a device constructed similarly to the above device to be used with chairs is provided. However, the lower end of the lower shaft section may need to be angled differently from the device used for chairs in order to correctly position the device, and particularly the lift handgrip, for convenient access by the user.

### BRIEF DESCRIPTION OF THE DRAWINGS

FIG. 1 is a side view of the fully telescoped crutch.

FIG. 2 is a side view of the fully nested crutch.

FIG. 3 is a side view of a wheelchair with a lift device including a telescoping shaft and auxiliary handgrip.

FIG. 4 is a side view of a bed with a lift device including a telescoping shaft and auxiliary handgrip.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

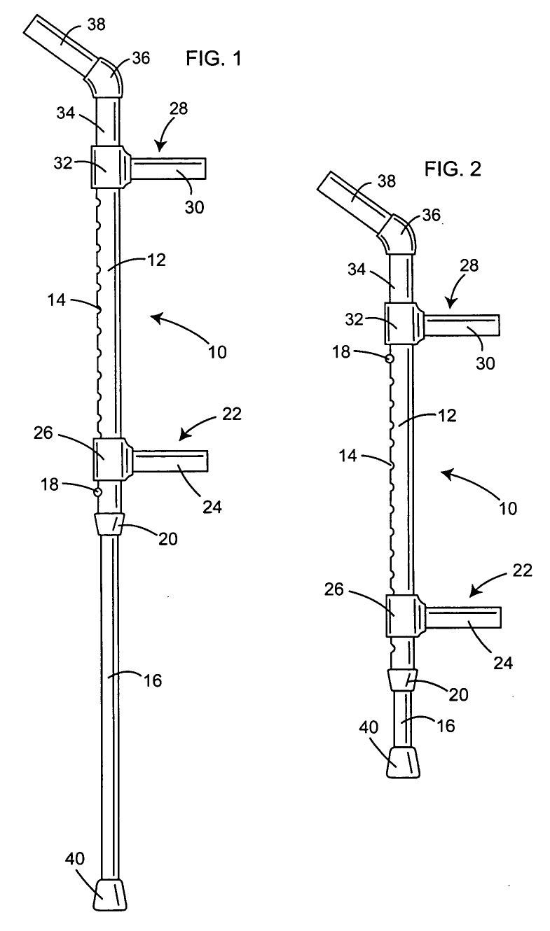

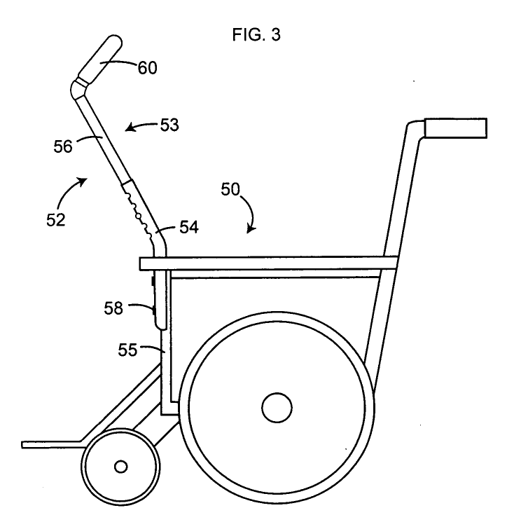

As shown in FIGS. 1 and 2, crutch, generally 10, is comprised of an upper shaft section 12 having a plurality of equally spaced, axially aligned holes 14, and a lower shaft section 16 that can be telescoped from within section 12. A spring-loaded button 18 attached near the upper end of section 16 is releasibly insertable within one of holes 14 to lock sections 12 and 16 at the desired telescoped length. Tubular cap 20 covers the intersection of sections 12 and 16.

Primary handgrip, generally 22, is comprised of a gripping member 24 slidably attached to shaft section 12 with band 26. Underarm support, generally 28, is positioned above handgrip 22, and is comprised of underarm member 30, and a tee fitting 32 to attach underarm support 28 to the top of shaft section 12. An additional shaft section 34, which may be about 3½″ in length extends upwardly from tee fitting 32. A 45° angle fitting 36 is attached at the top of section 34, with auxiliary lift handgrip 38 extending upwardly and outwardly from fitting 36. Tip 40 is inserted over the lower end of shaft section 16.

FIG. 3 illustrates a wheel chair, generally 50, having an attached lift device, generally 52, secured to a vertical frame member 54 at the front side of chair 50. Lift device 52 is comprised of a shaft, generally 53, comprised of lower telescoping shaft section 54 and upper telescoping shaft section 56, adapted to slide within section 54. It will be understood that the invention also contemplates a construction in which the shaft section with the smaller diameter is the lower shaft section.

The lower end of lower shaft section 54 is releasibly attached to vertical frame member 55 by bolts 58. Other releasibly attachment means, such as a clamp, can be used instead of bolts 58. Handgrip 60 extends in the direction of the back side of the chair from the upper end of upper shaft 56 at an angle from vertical of from about 30° to about 60°, and preferably about 45°, to be easily grasped by the user. Preferably, shaft 53 extends forward at an angle of about 10° to 45°, to facilitate positioning of handgrip 60.

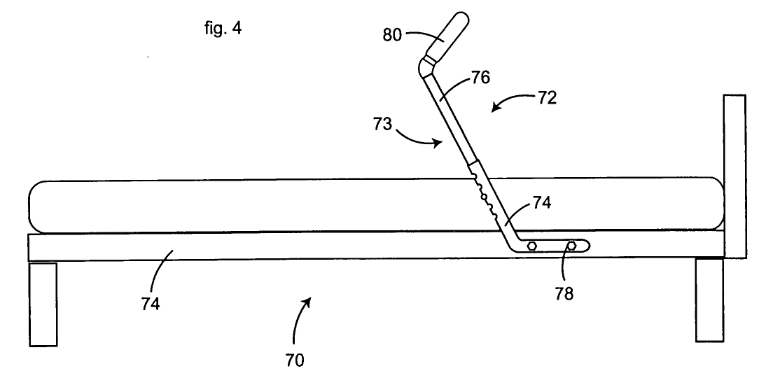

FIG. 4 illustrates a bed, generally 70, with a head, a foot and sides, and an attached lift device, generally 72, secured at a side of bed 70 to a horizontal frame member 74. Lift device 72 is comprised of a shaft, generally 73, comprised of lower telescoping shaft section 74 and upper telescoping shaft section 76, adapted to slide within section 74.

The lower end of lower shaft section 74 is releasibly attached to horizontal frame member 74 by bolts 78. Other releasibly attachment means, such as a clamp, can be used instead of bolts 78. Handgrip 80 extends toward the head of bed 70 from the upper end of upper shaft 76 at an angle from vertical of from about 30° to about 60°, and preferably about 45°, to be easily grasped by the user. Preferably, shaft 53 extends toward the foot of bed 70 at an angle of about 10° to 45°, to facilitate positioning of handgrip 80.

Certain modifications and improvements will occur to those skilled in the art upon a reading of the foregoing description. It should be understood that all such modifications and improvements are within the scope of the invention.

What is claimed is:

1. A telescoping crutch comprising:
a) an upper shaft section having an upper end;
b) a lower shaft section having a lower end, said lower shaft section being slidably positioned within said upper shaft section;
c) a first handgrip slidably positionable on said upper shaft section, said handgrip extending generally transversely from said upper shaft section;
d) an underarm support extending generally transversely from said upper shaft section above said first handgrip;
e) a lifting handgrip extending from the upper end of said upper shaft section at an angle to said upper shaft section, and to the side of said upper shaft section opposite from said lower handgrip.

2. The crutch of claim 1, wherein said lift handgrip extends at an angle of from about 30° to about 60° relative to said upper telescoping section.

3. The crutch of claim 1, wherein said lift handgrip extends at an angle of about 45° relative to said upper telescoping section.

4. The crutch of claim 1, wherein said upper shaft includes a plurality of equally spaced, axially aligned holes and said lower shaft includes a depressible button selectively positionable in one of said holes to secure said shaft sections in the desired telescoped relationship, said lower handgrip including a clamp selectively positionable on said upper shaft between adjacent holes.

5. The crutch of claim 1, wherein said lower and lower shaft sections are of substantially the same length, whereby substantially all of said lower shaft section can be inserted into said upper shaft section.

6. A chair adapted to facilitate rising of a user from said chair comprising:
a) a chair having a front side and a back side and a frame member; and
b) a telescoping shaft including a lower shaft section having an upper end and a lower end, the lower end of said shaft section being releasibly attached to said frame member, and an upper shaft section slidable within said lower shaft section, said upper shaft section having an upper end; and
c) a lifting handgrip extending toward the back side of said chair, said handgrip being positioned for gripping by a seated user when said shaft lower end is attached to said frame member.

7. The chair of claim 6, wherein said lift handgrip extends toward the back side of said chair at an angle of from about 30° to about 60° relative to vertical.

8. The chair of claim 6, wherein said lift handgrip extends toward the back side of said chair at an angle of about 45° relative to vertical.

9. The chair of claim 6, wherein said shaft extends outward from the front side of said chair at an angle of from about 10° to about 45° relative to vertical, and said lift handgrip extends toward the back side of said chair at an angle of from about 30° to about 60° relative to vertical.

10. The chair of claim 6, wherein said frame member is a vertical member located at the front side of said chair.

11. A bed adapted to facilitate rising of a user from said bed comprising:
a) a bed having a foot, a head, sides and a frame member; and
b) a telescoping shaft including a lower shaft section having an upper end and a lower end, the lower end of said shaft section being releasibly attached to said frame member, and an upper shaft section slidable within said lower shaft section, said upper shaft section having an upper end; and
c) a lifting handgrip extending from the upper end of said upper shaft section toward the head of said bed, said handgrip being positioned for gripping by a user reclined on said bed when said shaft lower end is attached to said frame member.

12. The bed of claim 11, wherein said lift handgrip extends toward the head of said bed at an angle of from about 30° to about 60° relative to vertical.

13. The bed of claim 11, wherein said lift handgrip extends toward the head of said bed at an angle of about 45° relative to vertical.

14. The bed of claim 11, wherein said shaft extends toward the foot of said bed at an angle of from about 30° to about 45° relative to vertical, and said lift handgrip extends toward the head of said bed at an angle of from about 30° to about 60° relative to vertical.

15. The bed of claim 11, wherein said frame member is a horizontal member located on the side of said bed.
